(19) United States
(12) Patent Application Publication
(10) Pub. No.: US 2019/0366425 A1
(43) Pub. Date: Dec. 5, 2019

(54) Ingot Casting

(71) Applicant: Grandfield Technology Pty Ltd, West Brunswick (AU)

(72) Inventors: John Francis Grandfield, West Brunswick (AU); Brian Philip Grandfield, Beauty Point (AU)

(21) Appl. No.: 16/061,635

(22) PCT Filed: Dec. 13, 2016
(86) PCT No.: PCT/AU2016/051225

§ 371 Date: Jun. 12, 2018

(30) Foreign Application Priority Data
Dec. 15, 2015 (AU) 2015905194

(51) Int. Cl. B22D 27/02; B22D 7/00; B22D 30/00; B01F 13/08; F27D 27/00

(52) U.S. Cl. CPC B22D 27/02; B22D 7/005; B01F 2215/0044; B01F 13/0809; F27D 27/00; B22D 30/00

(57) ABSTRACT

This specification discloses an open mould conveyer casting apparatus for forming a metal ingot including: a conveyer for conveying one or more ingot moulds from at least a first location where an ingot mould receives a molten metal having an exposed surface, to a second location where the molten metal has partially or completely solidified into a metal ingot; one or more magnetic field applicators configured to apply a varying magnetic field to the molten metal in the ingot mould between the first location and the second location, the magnetic field being of a magnetic field strength to induce stirring within the molten metal. This specification also discloses an open mould conveyer casting method for forming a metal ingot including: filling an ingot mould with a molten metal, the molten metal in the mould having an exposed surface; solidifying the molten metal to form the metal ingot; and applying a varying magnetic field to the molten metal of a magnetic field strength and frequency to induce stirring within the molten metal during the step of solidifying the molten metal.

### FIELD OF THE INVENTION

The invention relates to improved methods and systems for producing ingots with the application of a varying magnetic field.

### BACKGROUND OF THE INVENTION

Open mould ingot casting conveyors are used to cast large volumes of remelt ingots in a variety of metal alloys and ingot sizes. The metal alloys include a variety of both non-ferrous and ferrous alloys. For example, millions of tonnes of aluminium are cast every year using this method.

Remelt ingots may also be cast in large stationary sow moulds. Ingots produced in these open moulds, whether on a conveyor or stationary, suffer from the problem of shrinkage cavities. Unlike other shape castings they have no feeding system or reservoir, consequently as the ingot solidifies and the denser solid takes a smaller volume than the less dense liquid, shrinkage cavities can form. The shrinkage tends to be concentrated in the last portion of metal to solidify e.g. usually in the centre of the ingot which results in the formation of a central cavity, pores or cracks in the top surface of the ingot. The cavities can become filled with water and if the ingot is not adequately dried prior to being charged to a molten metal bath, a molten metal water explosion can result. Note that closed internal porosity is generally not a problem for these remelt ingots as water cannot enter these closed porous spaces. It is the open shrinkage cavities which water can enter that is of particular concern.

Alternatively, continuous casting processes can be used to produce remelt ingots. In the case of aluminium such processes include horizontal direct chill casting and wheel and belt casting. These processes tend to have fewer issues with the formation of pores or cavities than conveyor cast ingots. However, continuous processes have higher operating and capital costs than conveyor casting machines.

Another cavity formation problem occurs in direct chill casting, and in particular with rolling slab and T-Bar direct chill casting. In these processes, when the casting stops descending at the end of the cast, the feeding system is drained and the liquid metal feed is stopped. Shrinkage of the remaining molten metal pool causes cavity formation in the head of the ingot. In the case of remelt T-Bar ingot this creates similar problems as with sows and small ingots i.e. the possibility of water trapped in the cavities causing explosions during remelting. This necessitates the cutting of the head of the T-Bar ingot incurring losses. In the case of rolling slab, the head of the ingot containing the cavity must be removed before rolling the slab thus creating scrap material and economic loss.

Various techniques have been used in an attempt to control the formation of cavities in conveyor cast ingots. Wider, lower profile ingots tend to have fewer cavities. These wide ingots effectively reduce the contribution of mould wall cooling and encourage the solidification to proceed from the bottom of the mould upward which is desirable since the shrinkage merely results in a drop in the level of liquid in the mould across the whole top surface and no shrinkage cavities. Although a wide flat ingot tends to have a reduced cavity than a tall narrow ingot, the increased pitch of the conveyor (set by the inter-mould spacing which depends on the ingot width) results in significant reduction in casting line productivity.

Top water sprays have also been used in conveyer processes to create ingots that do not have an open shrinkage cavity. However, the use of water is undesirable as there is a risk that the water and molten metal will react, resulting in a molten metal explosion. Furthermore, there is a likelihood that water may penetrate through cracks and be retained in a sub-surface cavity within the ingot. The water may be difficult to remove, and may require long drying times.

Another technique that has been used to reduce the formation of cavities, and control ingot shrinkage is the application of heat to the top of the ingot during solidification. However, this method incurs extra energy costs and is not effective for metals, such as aluminium, which have a high latent heat.

Relatively pure alloys like the P1020 aluminium alloy with 99.85% aluminium minimum, are particularly prone to shrinkage cavities in the centre of the ingot because the solidification front tends to be planar with columnar grains growing from the mould walls and the base into the centre of the ingot and thus concentrating the shrinkage there. This growth pattern occurs due to the temperature gradient between the cooled mould and the hot interior. These alloys also have little alloy content to encourage grain refinement and no grain refiner is added so they tend to solidify with a columnar structure.

Stirring of the liquid melt in the mould during solidification of the ingot homogenises the temperature in the liquid pool and reduces the temperature gradient thus encouraging nucleation of equiaxed grains. These equiaxed grains may then settle to the bottom of the ingot effectively encouraging solidification from the bottom up. Additionally, the stirring removes dendrite fragments from the solidification front which then act as nuclei for equiaxed grain growth. Equiaxed grain growth also disperses the shrinkage throughout the ingot resulting in harmless small voidage porosity and less surface shrinkage cavities.

Mechanical stirring of the liquid in the ingot during solidification is one possible mechanism that can be adopted to alter the shrinkage characteristics. However, this results in poor surface quality and dross. There is also the possibility of introducing contaminants from the stirrer. Further, metal adheres to the stirrer increasing waste and creating a disposal problem.

It is an object of the invention to ameliorate at least one of the abovementioned problems of prior art metal ingot casting processes.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention there is provided an open mould casting method for forming a metal ingot including: filling an ingot mould with a molten metal, the molten metal in the mould having an exposed surface; solidifying the molten metal to form the metal ingot; and applying a varying magnetic field to the molten metal of a magnetic field strength and oscillating frequency to induce mixing (such as stirring) within the molten metal during the step of solidifying the molten metal. As used herein, the terms mixing and stirring are understood to be synonymous.

In an embodiment, the varying magnetic field is an oscillating magnetic field having a frequency of from about 1 to about 100 Hz. Preferably, about 5 to 50 Hz. More preferably, the oscillating magnetic field has a frequency of from about 20 to about 30 Hz.

The principle of using oscillating magnetics fields to induce stirring forces in non-magnetic metals is known. The use of oscillating magnetic fields has been used to creating stirring of the liquid melt in furnaces to reduce temperature and compositional variations in the melt, and has also been investigated for modifying the grain size of the solidifying crystals during continuous casting. In the case of continuous casting, the solidifying metal ingot moves through the oscillating magnetic field which is fixed relative to the mould. In the case of furnace stirring the stirrer can be positioned under the base of the furnace or used as an electromagnetic pump on the side of the furnace. However, the arrangement in these processes is very different from open mould conveyer casting processes, and as such cannot be applied to open mould conveyer casting processes.

Recently, F. Otsubo et al. (Otsubo et al. Materials Transactions, Vol. 55, No. 5 (2014), pp. 806-812), proposed the use of permanent magnetic stirring as a means of controlling grain size and porosity in shape castings. The configuration of Otsubo had two magnets rotating about a cylindrical mould. The distance between the magnets and the liquid metal was not given and the importance of this parameter was not discussed. The configuration of Otsubo, i.e. rotating around the casting on a vertical axis, is not possible on a conveyor where there is no room between moulds. Furthermore, the configuration of Otsubo discloses the use of ceramic moulds. Ceramic moulds are generally unsuitable for use in an open mould conveyer casting method. However, in the context of Otsubo, ceramic moulds are useful as these do not act to shield the contents from the oscillating magnetic field.

The ingot moulds need to be robust, strong, and heat resistant. Thus, in one or more embodiments the ingot mould is formed from a metal. Preferably, the metal is cast iron or steel. Preferably, the ingot mould is not formed from a ceramic material. Cast iron or steel moulds are the most commonly used moulds on a conveyor ingot casting or sow casting machine. However, these moulds act as an electromagnetic shield which prevents application of the oscillating magnetic field through the walls or the base of these moulds. As such, the system of Otsubo cannot be applied to a conveyor ingot casting system.

Calculations by Otsubo of their test configuration showed the magnetic field only created a mixing force on the molten metal in the outer part of the casting when a ceramic mould was used. The sample tested was only 36 mm in diameter. The smallest length dimension on remelt ingots is of the order of 500 mm or more. Some effect on internal porosity was found in their work but this configuration actually made the open shrinkage cavity worse because they encouraged solidification to proceed in from the walls. Additionally, these tests were conducted on a stationary mould. Application of the oscillating field requires an alternative configuration to that of Otsubo for moving moulds on an ingot conveyor.

Given the above, in a preferred embodiment, the magnetic field is applied to the molten metal from above the exposed surface. Preferably, the magnetic field is applied by one or more moving permanent magnets and/or one or more electromagnets at an offset distance of about 5 mm to about 30 mm above the exposed surface. Preferably, the offset distance is about 10 to about 20 mm. It is to be understood that various combinations of magnet field strength, magnet dimensions, offset distance to the ingot surface and oscillating field frequency may varied to achieve the desired stirring effect on the melt.

In an embodiment, the magnetic field strength is at least about 0.1 T. More preferably at least about 0.3 T. Preferably, the magnetic field strength is up to about 1.0 T. More preferably up to about 0.6 T.

In an embodiment, the magnet field is provided by one or more permanent or electromagnets, wherein at least one of the one or more magnets or each of the one or more magnets has a magnetic field strength of at least about 0.1 T. Preferably at least about 0.3 T.

In an embodiment, the magnet field is provided by one or more permanent or electromagnets, wherein at least one of the one or more magnets or each of the one or magnets has a magnetic field strength of up to about 1.0 T. Preferably, up to about 0.6 T.

In an embodiment, the magnetic field strength is sufficient to provide a pulling force in the range of from about 100 N to about 1,500 N. Preferably at least one of the magnets has a long dimension of about 25 mm to about 100 mm and about 100 to 2500 mm square cross section. More preferably, each magnet has a long dimension of about 40 to about 60 mm and about 300 to 1000 mm square cross section.

In an embodiment, the step of applying the magnetic field includes applying the magnetic field for a time period that is up to 20% of the total solidification time. For example, large sow aluminium ingots can take around 80 minutes to solidify (depending on process conditions). In this case, application of the oscillating field is for up to 20% of the total solidification time means that the treatment is applied for up to 16 minutes. It will of course be appreciated that different sized ingots will have different solidification times and the total application time will scale with the solidification time of the different sized ingots. For example, a 23 kg sized aluminium pure alloy ingot on a typical water cooled conveyor line take of the order of 5 minutes to solidify, in this case, 20% of the solidification time is 1 minute. Preferably, the application of the oscillating field is for up to 15% of the total solidification time. More preferably, application of the oscillating field is for up to 12% of the total solidification time. Even more preferably, application of the oscillating field is for up to 10% of the total solidification time. Most preferably, application of the oscillating field is for up to 8%of the total solidification time. Preferably, the application of the oscillating field is for at least 1% of the total solidification time. More preferably, application of the oscillating field is for at least 2% of the total solidification time. Even more preferably, application of the oscillating field is for at least 3% of the total solidification time.

In an embodiment, the oscillating field is applied for a period shortly after the ingots are filled. Preferably, within 120 seconds of filling the ingot mould. More preferably, within 90 seconds of filling the ingot mould. Most preferably, within 60 seconds of filling the ingot mould. In addition or alternatively, the step of applying the magnetic field includes applying the magnetic field when the temperature of the molten metal adjacent to the walls of the mould is cooled to a temperature that is less than 50° C. above the melting point of the molten metal. Preferably the temperature is within 20° C. of the melting point. Most preferably, the temperature is no greater than 10° C. above the melting point of the molten metal. This treatment encourages nucleation of equiaxed grains which are then dispersed throughout the bulk of the molten metal ingot. It is preferred that this treatment is applied for the durations specified above.

In an embodiment, the step of applying the magnetic field includes applying the magnetic field for a period near the end of solidification. The treatment at the second stage at the end of solidification is to homogenise the temperature and encourage solidification of a semi-solid mix rather than a liquid pool. The step of applying the magnetic field includes applying the magnetic field as the temperature of the molten metal near the centre of the ingot is cooled to a temperature that is about the melting point of the molten metal, such as a temperature within 5° C. of the melting point. Preferably the temperature is within 2° C. of the melting point. Most preferably, the temperature is the melting point of the molten metal.

In some cases it may be sufficient only to apply the treatment shortly before the end of solidification. In others, more than two treatment stages may be necessary depending on the size of the ingots. In an embodiment, the magnetic field is applied for a period shortly after the ingots are filled and for a period shortly before the end of solidification. It is preferred that this treatment is applied for the durations specified above.

In an embodiment, the step of solidifying the molten metal to form the metal ingot further includes cooling the exposed surface of the ingot to encourage crystal formation. Cooling methods may include air cooling and/or water mist cooling, such as blowing air and/or water mist onto the exposed surface.

In an embodiment, the method is an open mould conveyor casting method. Preferably, after the step of filling the ingot mould, the method further includes: conveying the ingot mould from at least a first location where the ingot mould received the molten metal, to a second location where the molten metal has partially or completely solidified into a metal ingot; and wherein the step of conveying the ingot mould includes transporting the ingot mould through one or more magnetic field zones to apply the varying magnetic field.

In an embodiment, the method is an open mould stationary casting method.

In an embodiment, the method is an open mould direct chill continuous casting method.

In another aspect of the invention, there is provided a metal ingot formed according to the method described herein.

In a further aspect of the invention, there is provided an open mould casting apparatus for forming a metal ingot including: an ingot mould for receiving a molten metal having an exposed surface; and one or more magnetic field applicators configured to apply a varying magnetic field to the molten metal in the ingot mould via the exposed surface, the magnetic field being of a magnetic field strength to induce mixing/stirring within the molten metal.

In still another aspect of the invention, there is provided an open mould conveyer casting apparatus for forming a metal ingot including: a conveyer for conveying one or more ingot moulds from at least a first location where an ingot mould receives a molten metal having an exposed surface, to a second location where the molten metal has partially or completely solidified into a metal ingot; one or more magnetic field applicators configured to apply a varying magnetic field to the molten metal in the ingot mould via the exposed surface between the first location and the second location, the magnetic field being of a magnetic field strength to induce mixing/stirring within the molten metal.

In an embodiment, the one or more magnetic field applicators are configured to apply an oscillating magnetic field having a frequency of from about 1 to about 100 Hz. Preferably, the oscillating magnetic field has a frequency of from about 20 to about 30 Hz.

The frequency and offset distance between the magnets and the metal can be adjusted throughout the solidification time to optimise crystal detachment. For example, in one embodiment, the step of applying a varying magnetic field includes a first step of applying a varying magnetic field to the molten metal of a first magnetic field strength and/or frequency; and subsequently a second step of applying a varying magnetic field to the molten metal of a second magnetic field strength and/or frequency.

It is preferred that the first frequency is from 1 Hz and up to 20 Hz. It is further preferred that the first step occurs during the early stages of solidification, such as for a duration of the initial 10% to 90% of a total duration of the step of applying the varying magnetic field. The use of a low frequency, such as in the range of 1 Hz to 20 Hz provides for a deeper penetration of the magnetic field into the ingot which encourages detachment of crystal fragments from the solidification front in the base and the walls.

It is preferred that the second frequency is from greater than 20 Hz and up to 30 Hz. It is further preferred that the second step is applied for a duration of from 90% to 10% of a total duration of the step of applying the varying magnetic field. The use of a high frequency, such as in the range of from greater than 20 Hz to 30 Hz encourages the detachment of crystals from the surface of the ingot.

Additionally or alternatively, the first step of applying a magnetic field is at a first offset distance between one or more permanent magnets and/or one of more electromagnets from the exposed surface; and the second step of applying a magnetic field is at a second offset distance between one or more permanent magnets and/or one of more electromagnets from the exposed surface; wherein the first offset distance and the second offset distance are different. Preferably the second offset distance is greater than the first offset distance. As discussed previously, a greater offset distance limits the stirring force and minimises splashing of molten metal out of the ingot mould.

In an embodiment, the magnetic field applicator includes one or more permanent magnets and/or one or more electromagnets located at an offset distance above the exposed surface, the apparatus further including a sensor configured to determine the offset distance between the exposed surface and the magnetic field applicator, the apparatus being configured to adjust the offset distance between the exposed surface and the magnetic field applicator to maintain the offset distance within a range of about 5 mm to about 30 mm. Preferably, the offset distance is about 10 mm to about 20 mm. Preferably, the sensor is a laser level sensor.

In an embodiment, the magnetic field strength is about 0.3 T to about 0.6 T.

In one or more embodiments, the one or more magnetic field applicators include one or more permanent magnets that are rotated over the exposed surface, the rotation generating the oscillating magnetic field.

In an embodiment, the one or more magnetic field applicators is located at a fixed position between the first location and the second location, and the conveyer conveys the one or more ingots under the one or more magnetic field applicators. Preferably, the one or more magnetic field applicators is free to rotate about the fixed position, or the one or more permanent magnets are free to rotate about the fixed position.

In an embodiment, the one or more magnetic field applicators are configured to move between at least the first position and the second position to apply the magnetic field to the molten metal in at least one of the one or more ingot moulds.

In a further embodiment related to direct chill continuous casting, the electromagnetic stirring is applied from above the ingot top surface when the cast is finished and the ingot has stopped descending. In this instance of direct chill casting the ingot is not moving horizontally and the field can be generated by an inductor (or spinning magnets) fixed to the liquid feeding system apparatus above the moulds.

In an embodiment, the apparatus further includes an air blower configured to cool the exposed surface, the air blower being located near to a first of the one or more magnetic field applicators to cool the exposed surface as the first of the one or more magnetic field applicators applies the magnetic field.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: Illustration of a typical ingot mould.

FIG. 2: Illustration of an embodiment of a magnet disc array.

FIG. 3: Illustration of an embodiment showing an arrangement of a magnet array with respect to the ingot mould.

FIG. 4: Illustration of an embodiment showing an arrangement where two or more magnets are arranged in a truncated cone with alternating poles.

FIG. 5: Illustration of an embodiment showing an arrangement where one or more horizontally aligned magnets are rotated about a horizontal axis through their centre.

FIG. 6: Illustration of an embodiment showing an arrangement where two or more magnets are arranged in the periphery of a barrel with alternating poles so that as the barrel is rotated about an horizontal axis through its centre an oscillating magnetic field is created.

FIG. 7: Illustration of an embodiment showing an arrangement where a magnetic field is applied via an AC current carrying coil.

FIG. 8: Photograph showing cross section of an air cooled 99.85% aluminium ingot with no magnetic treatment.

FIG. 9: Photograph showing top surface of an air cooled 99.85% aluminium ingot with no magnetic treatment.

FIG. 10: Photograph showing cross section of an air cooled 99.85% aluminium ingot with magnetic treatment applied during solidification.

FIG. 11: Photograph showing top surface of an air cooled 99.85% aluminium ingot with magnetic treatment applied during solidification.

### DETAILED DESCRIPTION OF THE EMBODIMENTS

The invention generally relates to the use of non-contact stirring by oscillating magnetic fields during solidification of a metal melt to control the shrinkage cavities forming in open mould conveyor cast ingots, such as sow casting carousels and continuous lines. The method can be applied to all metals and conducting materials cast in open moulds including aluminium, ferro alloys, silicon, and electrical conducting slags or salts which are sometimes cast into sow moulds such as NaCl-KCl salts used in the recycling of aluminium.

The embodiments and examples generally describe the application of a magnetic field using rotating magnets. However, it is to be understood that the oscillating magnetic fields can be created either by AC current and coils or by rotating magnets to achieve the same effects. One advantage of electromagnetic fields created by AC current over moving magnets is that multiple frequency components can be applied at the same time. For example, a low frequency of 10 Hz could be applied at the same time as a higher frequency of 40 Hz. Thereby, different parts of the ingot can be stirred at the same time. Thus, in certain forms of the invention, the magnetic field applicators are AC electromagnets, and the step of applying a magnetic field can include simultaneously applying magnetic fields of different frequency to the molten metal. Despite this, permanent magnets are preferred over AC current as these are more economical due to lower energy consumption and operating costs.

To induce mixing/stirring within a metal melt, or a solidifying metal melt, an oscillating magnetic field is applied through the use of permanent magnets or electromagnets. In a preferred form of the invention, the oscillating magnetic field is provided by permanent magnets that are rotated above the molten metal or solidifying ingot. In any event, the application of the oscillating magnetic field induces liquid movement within the solidifying ingot. This liquid movement disperses solid fragments (which may be referred to as crystallites or seed crystals) throughout the bulk of the molten metal. This advantageously:
(i). grows and settles onto the solidification front in the base of the ingot encouraging solidification to proceed from the base of the mould and less so from the sides;
(ii). creates a semi-solid region where shrinkage is dispersed over a larger volume and not only in the central region; and
(iii). reduces shrinkage cavities and disperses porosity.

The timing and duration of the oscillating magnetic field to the solidifying ingot is important. Generally, it is preferred that the oscillating magnetic field is applied at least during the initial phases of solidification during which solid crystallites have formed adjacent the walls and base of the ingot mould so that these crystallites may be dispersed throughout the bulk molten metal of the solidifying ingot. In this regard, it is preferably to include enhanced air cooling of the top surface of the ingot during this initial phase to assist in the formation of seed crystals which can then be dispersed within the melt via the mixing/stirring force created by the oscillating magnetic field. This enhanced air cooling may be provided by standard means known in the art, such as using a fan or blower. Water mist cooling may also be used to similar effect.

It is further preferred that the oscillating magnetic field is again applied near the end of solidification in order to homogenise the temperature distribution in the melt. The timing of the duration of the application of the magnetic field is to be adjusted according to the solidification time of the ingot which will depend on the size, shape and dimensions of the ingot.

While the ingot solidification time is dependent on the size, shape and dimensions of the ingot; the mould cooling method (air or water); and the melt temperature, generally the solidification process includes a number of distinct phases. Generally, for the costing temperature of the liquid entering the mould is up to 100° C. above the melting point. A temperature 50° C. above is reached after 10 to 20 seconds for 23 kg ingots. The melting point is usually reached after 40 seconds for 23 kg ingots. For a standard 23 kg pure aluminium remelt ingot cooled with water cooling of the mould, the typical solidification time is around 300 seconds. For large aluminium sows of around 700 kg the solidification time may be around 4800 seconds.

Initially, grains nucleate on the mould and form a solid shell defined by the inner dimensions of the mould and the solidification front. The solidification front from the walls and the base of the mould migrates, over time, toward the centre of the ingot where final solidification occurs. The time taken for solidification after filling the mould, is the time it takes for the solidification front to progress from adjacent the mould walls and into the centre of the ingot so that no molten metal liquid remains.

The solidification time can be determined by freezing in thermocouples into the ingot, and mathematically modelling the solidification to make solidification time predictions. Observations of the top liquid surface during solidification also give some indication of the solidification time. In this manner the solidification time is known for a given alloy and ingot size and shape and the oscillating magnetic field treatment stages and times can be adjusted accordingly.

In the case of a standard 23 kg pure aluminium remelt ingot cooled with water cooling of the mould, the oscillating field is ideally applied for a short duration part way through the solidification e.g. at around 60 seconds after filling the ingot mould for a duration of 10 to 20 seconds. The oscillating field helps to disperse seed crystals which will lead to a semisolid mush at the end of solidification. Toward the end of solidification the field is applied again in order to homogenise the temperature distribution in the melt.

Generally, the magnetic field is applied from above the ingot. This is because the walls and base of the ingot mould act as a magnetic shield that prevents the magnetic field from adequately penetrating the solidifying melt to induce mixing/stirring. As above, the use of permanent magnets is desired due to more favourable economics. Neodymium magnets are particularly preferred. However, magnets formed of other materials may be used if they have suitable field strength and pulling force.

In order to provide an oscillating magnetic field, the permanent magnets are rotated over the surface of the solidifying melt. The frequency of field oscillation depends on the RPM of the device and the number of magnets. To achieve a suitable penetration depth into the ingot of the forces acting on the metal, a low frequency in the range 1 to 100 Hz, preferably 5 to 50 Hz, and most preferably 20-30 Hz is used. To get sufficient stirring force requires a small offset distance between the magnets and the surface of the melt of 5-20 mm preferably around 10 mm.

Generally, one or more magnets will be held in a magnetic field applicator or jig above the solidifying melt. The jig used to hold and rotate the magnets also should be made of a non-magnetic material, mechanically sound and sufficiently heat resistant. Preferably, the jig is formed from a material selected from the group consisting of aluminium, PTFE, wood, or copper based alloys. Preferably the jig includes milled slots for containing the magnets in set positions and a cover plate to hold them in the milled slots.

The magnets may be held in a number of different arrangements within the jig. The magnets can be rotated around a vertical or horizontal axis above the moulds. The axis of rotation may be held in a fixed position as the moulds on the conveyor pass underneath or may travel a defined path in relation to the moulds. For example the axis of rotation may travel up and down the length of the ingot within a defined time frame as it moves along the conveyor.

The jig can be fixed in position above the conveyor or move along with the moulds. A number of different arrangements of the jig and the magnets held therein are contemplated.

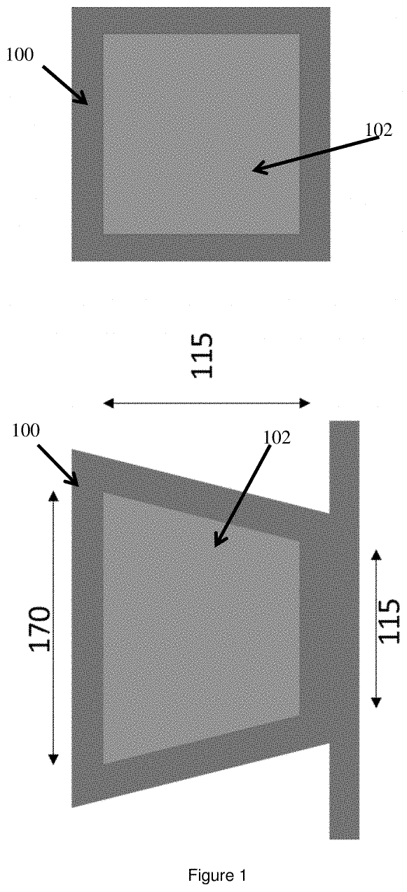

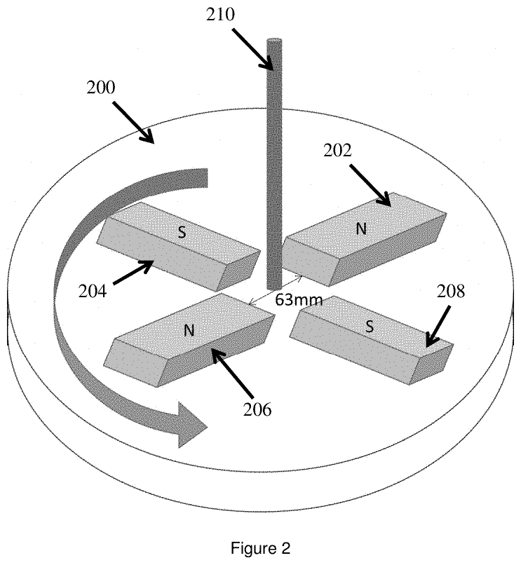

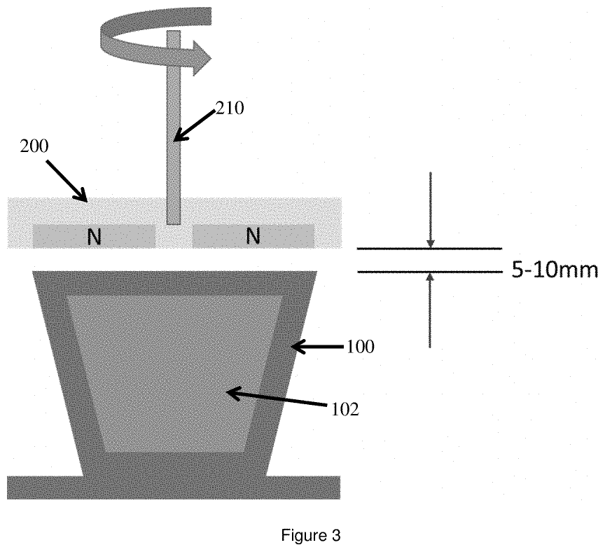

In one example, permanent magnets are held within the jig (or magnetic field applicator) such that the permanent magnets are rotated about a vertical axis above the exposed surface of the molten metal (such as in a typical ingot mould 100 filled with a metal ingot 102 as shown in FIG. 1). In this case, the term vertical axis denotes an orientation that is substantially perpendicular to the exposed molten metal surface. This is best illustrated in FIGS. 2 and 3. FIG. 2 illustrates a disc shaped jig or magnetic field applicator 200 holding four permanent magnets (each 50×20×12.5 mm) 202, 204, 206, 208 in an alternating pole arrangement retained held in a planar manner (in a plane parallel with the exposed surface of the molten metal). The jig 200 is rotated about a vertical axis in the direction shown. The rotation may be either clockwise or anticlockwise. Still further, the direction of rotation may be alternated between clockwise and anti-clockwise in order to perturb the thermal field at the solidification front and encourage crystal detachment from the solidification front. FIG. 3 shows a side view of the jig 200 of FIG. 2 held 5 to 10 mm above an ingot mould 100 filled with a molten material 102. The jig 200 is rotated about a vertical axis 210 in the direction shown.

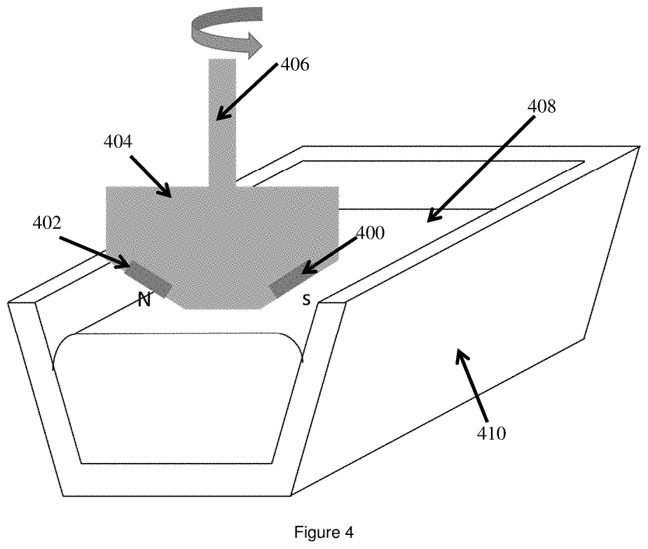

Alternatively, as shown in FIG. 4, two magnets 400 and 402 with alternating poles are or mounted into a jig or magnetic field applicator 404 having an inverted frustoconical shape which is rotated about a vertical axis 406 above the exposed surface of the molten metal 408 held in a ingot mould 410, such that each of the magnets are angled relative to the surface if the molten metal (i.e. not arranged parallel to the molten metal surface). In this case, the magnets are angled away from the exposed surface with distance from the vertical axis.

The position of the vertical axis can vary in relation to the mould/ingot for example moving back and forward from one end of the ingots to the other. That is, in one or more embodiments, the vertical axis can translate over the exposed surface. The jig or magnetic field applicator may also be raised and lowered over the exposed surface. The vertical axis may also be in a fixed position relative to the ingot, this position may be in the centre of the ingot above the exposed surface or in an off centre position, for example at one quarter of the ingot width.

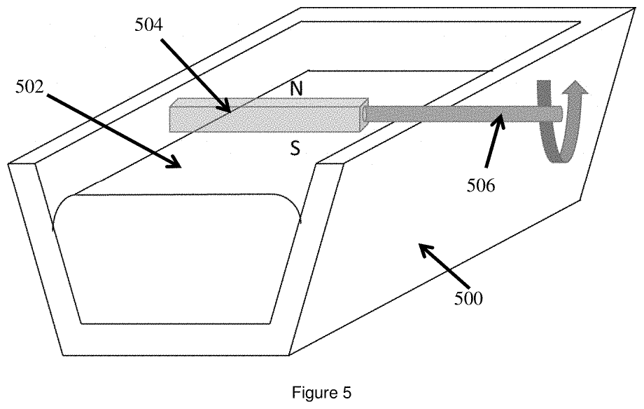

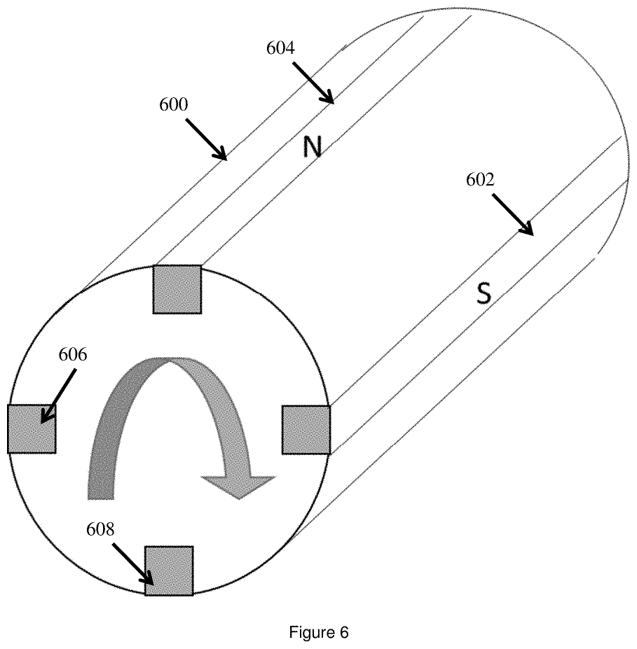

An array of an even number of more than four magnets radially spaced at equal angles could also be used. Alternate magnet arrays and stirring patterns are also possible. For example, in an alternate configuration, a row of long magnets is provided with poles on their sides rotating about horizontal axes through their centre. This arrangement is illustrated in FIGS. 5 and 6 in respect of a single rotating magnet that is rotated about a horizontal axis (that is, the axis is in the same plane as the exposed molten metal surface). It will be appreciated that a plurality of magnets in this arrangement could be employed.

FIG. 5 shows an ingot mould filled with a molten metal have an exposed molten metal surface 502. Held above the exposed molten metal surface is a jig or magnetic field applicator 504 having four faces with alternating polarity. The faces are rotated about a horizontal axis 506 in the illustrated direction.

FIG. 6 shows a further arrangement of a jig or magnetic field applicator 600 having a cylindrical shape and including therein four magnets 602, 604, 606, and 608 for rotation about a horizontal axis in a similar manner to that illustrated in FIG. 5.

In each case, the invention encompasses embodiments where the jig or magnetic field applicators are held in position, or are able to move. Typically, for a conveyor type system, the jig or magnetic field applicators are held in a static position relative to the process, with a magnetic field generating portion that is free to rotate (in the case of permanent magnets) to provide the varying or oscillating magnetic field. Alternatively, the jig or magnetic field applicators may be able to move with the ingot moulds along the conveyor, such that each ingot is associated with its own jig or magnetic field applicator. In still another alternative arrangement, the jig or magnetic field applicators may be free to move within a confined portion of the process, such that the jig or magnetic field applicator can move with an ingot from an initial point in the process where application of the oscillating magnetic field is commenced to a final point where application of the oscillating magnetic field is ceased. Once the jig has reached this final point, the jig returns to the initial point to be associated with a new ingot, while the ingot continues to be conveyed for further downstream processing (such as further cooling etc.).

In a preferred arrangement, the magnets are held within a star arrangement of four magnets, for example, in one embodiment four 50×20×12.5 mm Neodymium magnets of 0.6 Tesla strength were used. The magnets are positioned in a frame of the jig with adjacent magnets having alternating poles. The magnets are rotated about a vertical axis in a horizontal plane above the surface of the melt.

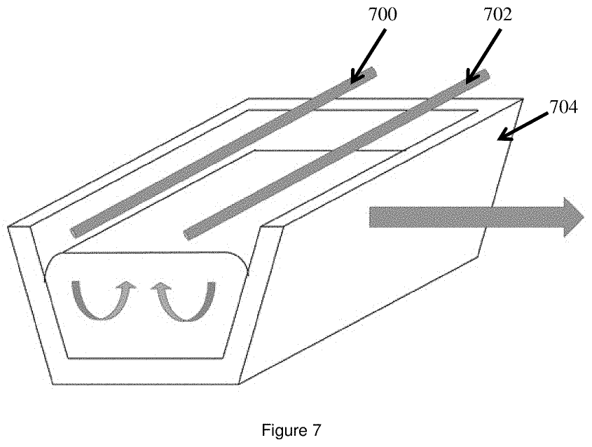

In yet another embodiment, as illustrated in FIG. 7, the magnetic field is applied by a series of AC current carrying coils 700 and 702. In this embodiment the coils 700 and 702 are held in a fixed position and the mould 704 is carried by a conveyor underneath the series of AC current carrying coils.

Irrespective of the specific arrangement that is chosen, during normal operation there is some variation in ingot pour weight and consequently the height of the liquid in the mould. To maintain a constant offset distance between the magnets (such as, in certain embodiments, the plane of rotation of the magnets) and the liquid surface of the solidifying ingot with every ingot cast, a laser sensor is used to measure the level of metal in the mould and the vertical position of the magnets (which in certain embodiments is in the form of a rotating disk containing the magnets) is adjusted accordingly.

The variation in ingot weight from a nominal weight causes the solidification time of the ingots to vary and thus the last stage of solidification along the conveyor also varies. Multiple magnetic field treatment heads or stations may be used to ensure all ingots received treatment at the correct time in the solidification process. For example for nominal 23 kg ingots, there may be a variation in the weight of the ingots of plus or minus 1 kg from the nominal weight. As a result, the solidification time may vary by up to 30 seconds which, depending on the conveyor speed, can result in a 2 metre variation in the point of final solidification along the conveyor. In this case, the use of two treatment stations 2 meters apart can ensure all ingots are treated before final solidification for a sufficient period.

### EXAMPLE

Tests were conducted on a square steel mould 12.5 mm thick with a cross section typical of 23 kg remelt ingots (see FIG. 1). Ingots produced were around 4.5-5 kg. When natural air cooling was used the solidification time was about 5 minutes.

FIG. 2 shows a disc array of four magnets seated in a rotating disc above the surface of the melt, with alternating north and south poles. The disc array was constructed of wood with an aluminium cover plate to hold the magnets in place. Four 50 mm long 20×12.5 mm 0.64 Tesla magnets were used with alternating poles. Magnets were positioned 31 mm from the central axis within the disk on the underside of the disk (FIG. 2). A shaft was connected to the disk allowing the disk to be rotated with an electric motor. The array was rotated at 400 RPM, giving a field oscillation frequency of 27 Hz. The array was held 5-10 mm above the mould and 20-25 mm from the melt surface in the mould after filling as shown in FIG. 3.

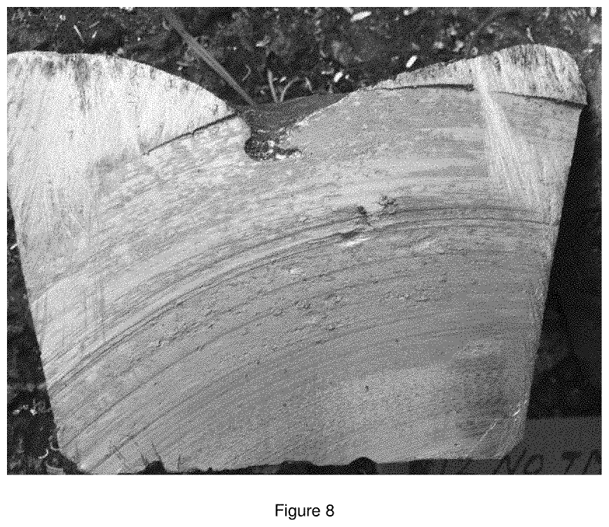

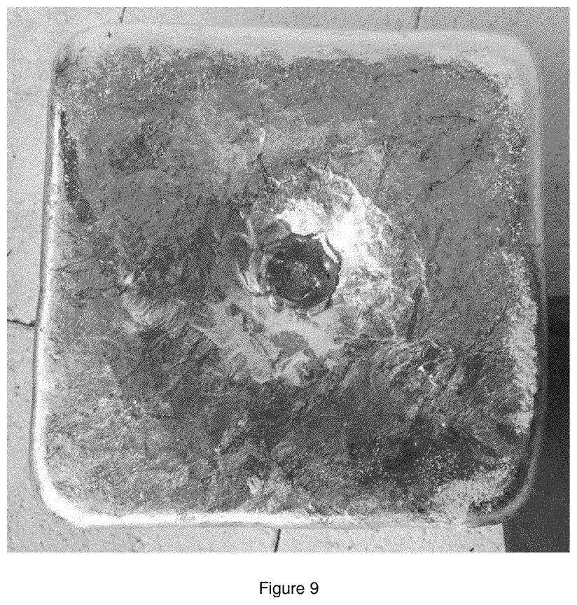

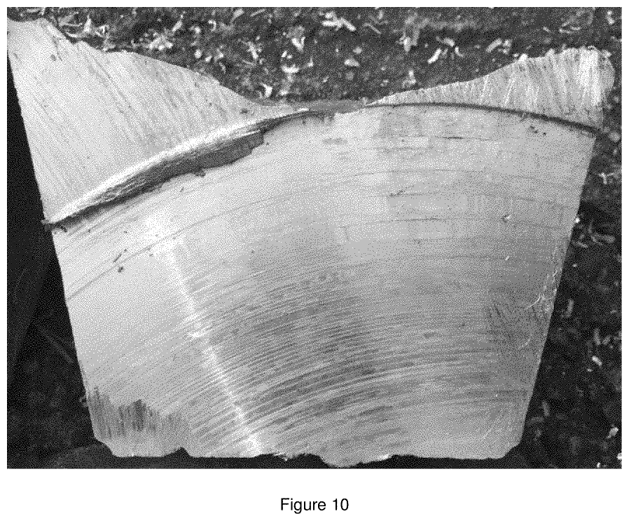

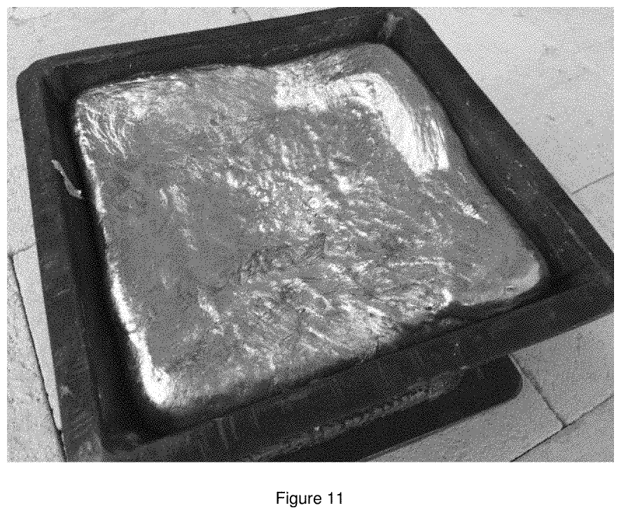

When casting with natural air cooling, the resulting shrinkage cavities were large and located in the centre of the ingot (FIGS. 8 and 9). When the oscillating magnetic field was applied to induce mixing/stirring during solidification the central cavity was eliminated (FIGS. 10 and 11).

It will be understood that the invention disclosed and defined in this specification extends to all alternative combinations of two or more of the individual features mentioned or evident from the text or drawings. All of these different combinations constitute various alternative aspects of the invention.

1. An open mould casting method for forming a metal ingot including:
filling an ingot mould with a molten metal, the molten metal in the mould having an exposed surface;
solidifying the molten metal to form the metal ingot; and
applying a varying magnetic field to the molten metal of a magnetic field strength and frequency to induce stirring within the molten metal during the step of solidifying the molten metal.

2. The method of claim 1, wherein the varying magnetic field is an oscillating magnetic field having a frequency of from about 1 to about 100 Hz.

3. The method of claim 2, wherein the oscillating magnetic field has a frequency of from about 20 to about 30 Hz.

4. The method of claim 1, wherein the magnetic field is applied by one or more permanent magnets and/or one or more electromagnets at an offset distance of about 5 mm to about 30 mm above the exposed surface.

5. The method of claim 4, wherein the offset distance is about 10 to about 20 mm.

6. The method of claim 1, wherein the magnetic field strength is at least about 0.3 T.

7. The method of claim 1, wherein the step of applying the magnetic field includes applying the magnetic field for a period of up to 20% of the total solidification time.

8. The method of claim 1, wherein the step of solidifying the molten metal to form the metal ingot further includes blowing air or a water mist on to the exposed surface to cool the exposed surface.

9. The method of claim 1, wherein the method is selected from a group consisting of: an open mould stationary casting method; an open mould direct chill continuous casting method; and an open mould conveyor casting method.

10. The method of claim 9, wherein the method is an open conveyor casting method and after the step of filling the ingot mould, the method further includes:
conveying the ingot mould from at least a first location where the ingot mould received the molten metal, to a second location where the molten metal has partially or completely solidified into a metal ingot; and
wherein the step of conveying the ingot mould includes transporting the ingot mould through one or more magnetic field zones to apply the varying magnetic field.

11-13. (canceled)

14. An open mould casting apparatus for forming a metal ingot including:
an ingot mould for receiving a molten metal having an exposed surface; and
one or more magnetic field applicators configured to apply a varying magnetic field to the molten metal in the ingot mould via the exposed surface, the magnetic field being of a magnetic field strength to induce stirring within the molten metal.

15. An open mould conveyer casting apparatus for forming a metal ingot including:
a conveyer for conveying one or more ingot moulds from at least a first location where an ingot mould receives a molten metal having an exposed surface, to a second location where the molten metal has partially or completely solidified into a metal ingot;
one or more magnetic field applicators configured to apply a varying magnetic field to the molten metal in the ingot mould via the exposed surface between the first location and the second location, the magnetic field being of a magnetic field strength to induce stirring within the molten metal.

16. The apparatus of claim 14, wherein the one or more magnetic field applicators are configured to apply an oscillating magnetic field having a frequency of from about 1 to about 100 Hz.

17. (canceled)

18. The apparatus of 14, wherein the magnetic field applicator includes one or more permanent magnets and/or one or more electromagnets located at an offset distance above the exposed surface,
the apparatus further including a sensor configured to determine the offset distance between the exposed surface and the magnetic field applicator, the apparatus being configured to adjust the offset distance between the exposed surface and the magnetic field applicator to maintain the offset distance within a range of about 5 mm to about 30 mm.

19. The apparatus of claim 18, wherein the offset distance is about 10 mm to about 20 mm.

20. (canceled)

21. The apparatus of claim 14, wherein the magnetic field strength of about 0.1 T to about 1 T.

22. The apparatus of claim 16, wherein the one or more magnetic field applicators include one or more permanent magnets that are rotated over the exposed surface, the rotation generating the oscillating magnetic field.

23. The apparatus of claim 15, wherein the one or more magnetic field applicators is located at a fixed position between the first location and the second location, and the conveyer conveys the one or more ingots under the one or more magnetic field applicators.

24. The apparatus of claim 23, wherein the one or more magnetic field applicators is free to rotate about the fixed position, or the one or more permanent magnets are free to rotate about the fixed position.

25. The apparatus of claim 15, wherein the one or more magnetic field applicators are configured to move between at least the first position and the second position to apply the magnetic field to the molten metal in at least one of the one or more ingot moulds.

26. The apparatus of claim 14, wherein the apparatus further includes an air blower or water mist spray configured to cool the exposed surface, the air blower being located near to a first of the one or more magnetic field applicators to cool the exposed surface as the first of the one or more magnetic field applicators applies the magnetic field.
